(19) United States
(12) Patent Application Publication
(10) Pub. No.: US 2006/0087142 A1
(43) Pub. Date: Apr. 27, 2006

(54) Sedan roof sucked LCD monitor holder

(75) Inventor: Sheng-Fu Lu, Taoyuan Hsien (TW)

Correspondence Address: TROXELL LAW OFFICE PLLC, Suite 1404, 5205 Leesburg Pike, Falls Church, VA, 22041, US

(73) Assignee: Chi Sam Electronic Enterprise Co., Ltd.

(21) Appl. No.: 10/973,384

(22) Filed: Oct. 27, 2004

(51) Int. Cl. B60R 7/00

(52) U.S. Cl. 296/37.7

(57) ABSTRACT

A sedan roof sucked LCD monitor holder mainly comprises a holder and a swing door. The holder is normally sucked on the sedan roof providing accommodation to hold the DVD and VCD monitor. This holder can be mounted at any place inside the sedan without occupying large room. Once the swing door is opened, the passengers sitting in sedan can watch the movie at the best visible angle.

### BACKGROUND OF THE INVENTION

1. Field of the Invention

This invention relates to a sedan roof sucked LCD monitor holder, easy and convenient to carry with.

2. Description of the Related Art

In general the LCD monitor holder is a basic auxiliary the automobile manufacturer attached to the sedan or an additional auxiliary the sedan owner brought on purpose to mount in the sedan, both of which are permanently fixed in the sedan, not easy to dismount. Due to poor social order, it becomes a lure to attract burglary.

### SUMMARY OF THE INVENTION

Due to the weak point that the fixed LCD monitor holder mounted in sedan is inevitably subject to burglary, the inventor has devote a great efforts for years to improvement and eventually come up with a portable LCD monitor holder which can be sucked on the sedan roof to meet the industrial requirement.

The main object of this invention is to provide a portable LCD monitor holder to house DVD or VCD. The holder can be mounted at any place inside the sedan without occupying too much room. When the swing door is opened, the passengers inside the sedan cam watch the movie replayed by DVD or VCD at the best visible angle.

### BRIEF DESCRIPTIONS OF THE DRAWINGS

FIG. 1 shows the elevation of outlook of the LCD monitor holder of this invention.

FIG. 2 shows the opening condition of the LCD monitor holder of this invention.

FIG. 3 shows the disassembly of the LCD monitor holder of this invention.

FIG. 4 shows mounting LCD monitor on the door flap.

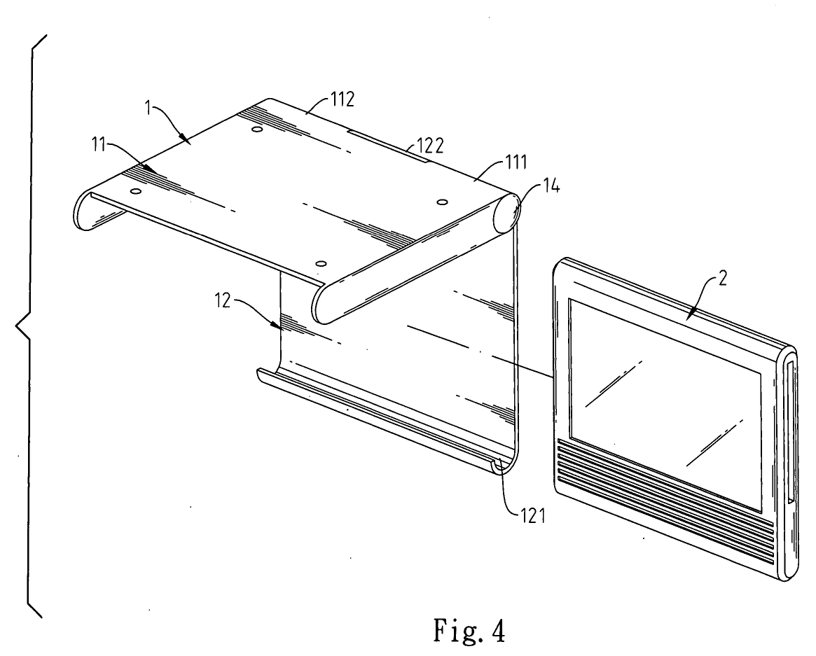

FIG. 5 shows the elevation of the LCD monitor holder of this invention.

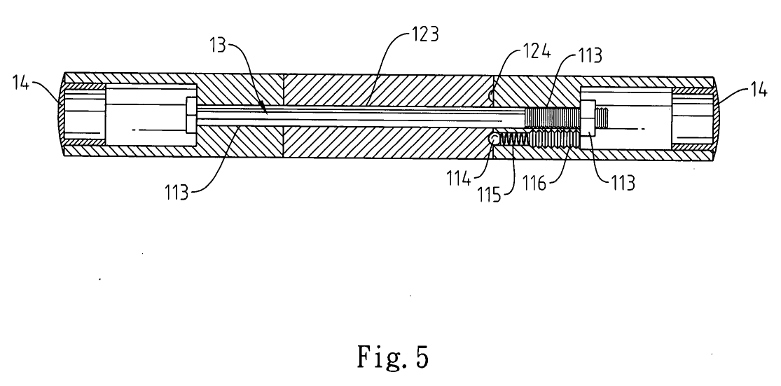

FIG. 6 shows the operation of the LCD monitor holder of this invention.

### DETAILED DESCRIPTION OF THE PREFERRED EMBODIMENT

The invention is explained in great detail with the aid of the embodiments as illustrated in the drawings attached.

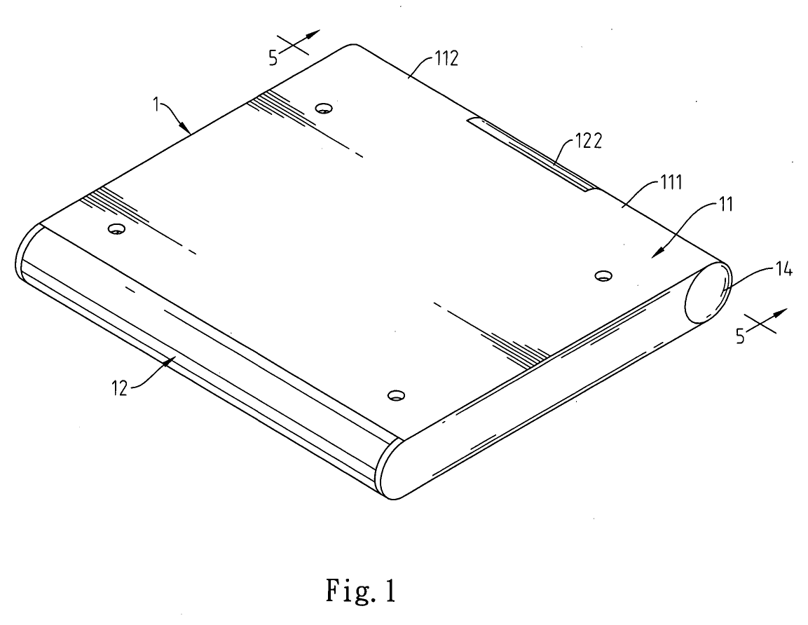

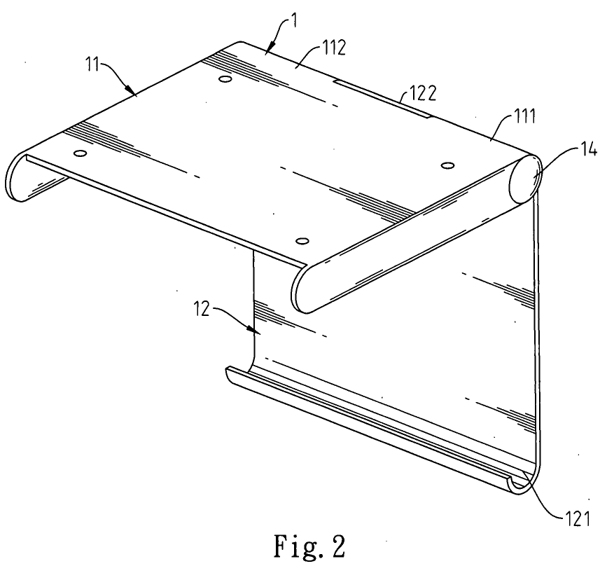

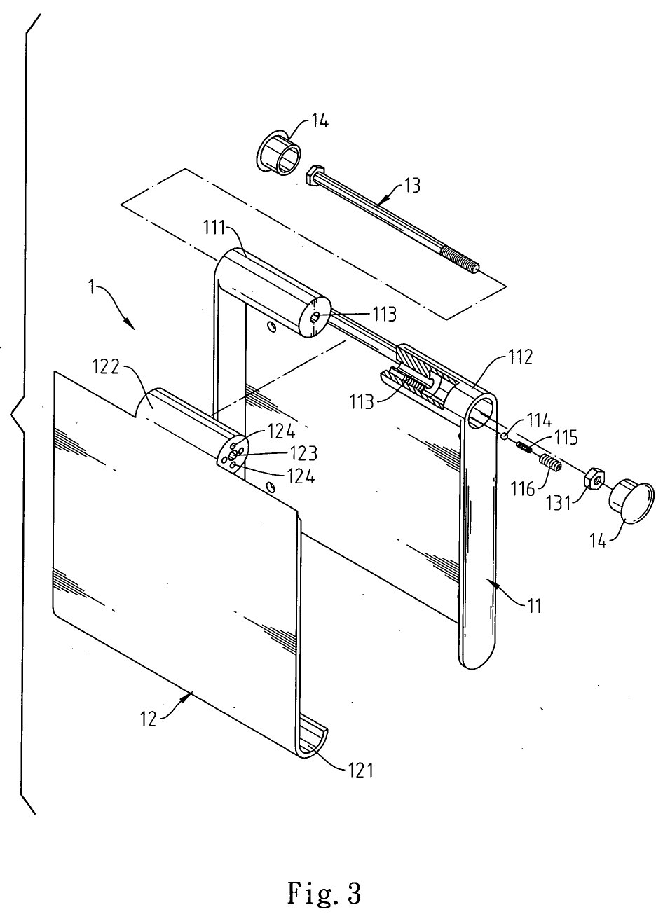

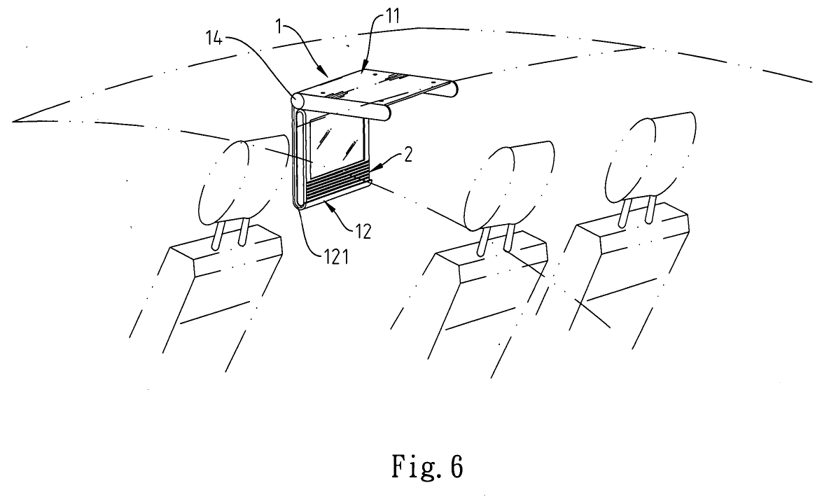

Please refer to FIGS. 1 through 3 and 6, the LCD monitor holder 1 of the invention consists of a fixed frame 11 and a swing door 12 linked together by knuckles and joint. The fixed frame 11 can be fixed inside sedan (figure shows the holder is fixed on the sedan roof.) the accommodation formed between the fixed frame 11 and the swing door 12 can hold host of DVD and VCD.

The swing door 12 is linked to the holder 1 by means of knuckles and joint. When the swing door 12 is opened, the host of DVD and VCD begin to play the movies. The holder has two knuckles 111, 112 at one far end. The space between two knuckles 111, 112 is for connecting the joint 122 of the swing door 12. The knuckles 111 and 112 have an axial hole 113 to accept the lock pin 13. The axial hole 113 in the knuckle 112 will receive the catch ball 114, spring coil 115 and bolt shank 116. The joint 122 of the swing door 12 is placed in the space formed by the knuckles 111 and 112. The axial pin 13 will pierce through the axial holes 113 and 123 in the knuckles 111, 112 and joint 122 and they are locked together by the nut 131. When the fixed frame 11 and swing door 12 are connected, the knuckles 111, 112 will be sealed by the decorative plugs 14 at both ends to keep the appearance more beautiful.

The axial hole 123 of same side of joint 122 of the knuckle 112 opposites the swing door 12; the joint provides several retaining holes 124 around the axial hole 123. When the swing door turning on the knuckles 111 & 112 of fixed frame 11, the catch ball 114 will fall into one of the retaining hole 123 to keep the swing door 12 at the opening angle the passenger desires.

When the swing door 12 is opened, the door flap 121 provides sufficient room to hold the host 2 of DVD and VCD, then gradually swing the swing door 12 to an angle till the catch ball 114 of the knuckle 112 falls into the retaining hole 123 of the joint 122.

Viewing from the above statement, it is learned that the sedan roof sucked LCD monitor holder provided in this invention is the best portable devise to hold DVD and VCD, a novel design justified for a grant of a patent. Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What the invention claimed is:

1. A sedan roof sucked LCD monitor holder mainly comprises a fixed frame and a swing door with the major characteristics on:
the holder has two knuckles at one end separated with a space; the knuckle has a go through axial hole to receive the lock pin; one knuckle axial hole will contain catch ball, spring coil and bolt shank, the fastening elements;
the joint of the swing door is placed in the space between two knuckles; there are several retaining holes around the axial hole to receive the catch ball of the knuckle so the swing door is always kept open at the best visible angle.
